(19) United States
(12) Patent Application Publication
(10) Pub. No.: US 2025/0231795 A1
(43) Pub. Date: Jul. 17, 2025

(54) METHOD FOR EXECUTING TASK SCHEDULING AND RELATED PRODUCTS THEREOF

(71) Applicant: CAMBRICON (XI'AN) SEMICONDUCTOR CO., LTD., Shaanxi (CN)

(72) Inventors: JIAN GAO, Shaanxi (CN); YONGZHENG HAO, Shaanxi (CN)

(21) Appl. No.: 18/852,880

(22) PCT Filed: Dec. 12, 2022
(86) PCT No.: PCT/CN2022/138473

§ 371 Date: Sep. 30, 2024

(30) Foreign Application Priority Data
Jun. 7, 2022 (CN) 202210641721.5

(51) Int. Cl. G06F 9/48; G06F 9/38; G06F 11/07

(52) U.S. Cl. CPC G06F 9/4881; G06F 9/3885; G06F 11/0766

(57) ABSTRACT

A task scheduler is arranged in an artificial intelligence processor. The artificial intelligence processor includes an executing circuit configured to execute a task. The task scheduler includes a first sending circuit configured to send a prefetch task of a next task to the executing circuit during an execution of a real task of a current task by the executing circuit, wherein a task in the task scheduler is split into a prefetch task and a real task that are interrelated, and a second sending circuit configured to send a real task of the next task to the executing circuit after the executing circuit has completed an execution of the prefetch task of the next task, so that the executing circuit executes the real task of the next task after the executing circuit has completed the execution of the real task of the current task.

### CROSS REFERENCE OF RELATED APPLICATIONS AND CLAIM OF PRIORITY

This application claims benefit under 35 U.S.C. 119, 120, 121, or 365 (c), and is a National Stage entry from International Application No. PCT/CN2022/138473, filed Dec. 12, 2022, which claims priority to the benefit of Chinese Patent Application No. 202210641721.5 filed on Jun. 7, 2022, in the Chinese Intellectual Property Office, the entire contents of which are incorporated herein by reference.

### BACKGROUND

### 1. Technical Field

The present disclosure generally relates to a computer field. More specifically, the present disclosure relates to a method for executing task scheduling, a task scheduler configured to perform the aforementioned method, an artificial intelligence processor, a board card, a device, and a computer-readable storage medium.

### 2. Background Art

Traditional central processing units (CPU) usually use multi-threading technology to design micro-architectures to improve parallel processing performance, and the same situation applies to graphics processing units (GPU) in the field of artificial intelligence. The advantage of multi-threading is that it takes full advantage of parallelism between threads and may provide parallelism at a higher level. However, the disadvantage of multi-threading is that it increases hardware complexity and increases thread switching overheads. Due to the high complexity of the multi-threading technology, the more threads there are, the more complex the control logic becomes. As a result, the overheads brought by thread switching are also greater, and the benefits brought are not always positive. In view of this, how to reduce the complexity of the multi-threading technology and obtain stable performance benefits is an urgent problem to be solved.

### SUMMARY

In view of the technical issues mentioned in the background, the present disclosure proposes a scheme for executing task scheduling efficiently. A dual-threaded architecture with relatively low complexity and good performance benefits may be realized by using the scheme of the present disclosure. To this end, the present disclosure provides a task scheduling scheme in the following aspects.

A first aspect of the present disclosure provides a task scheduler arranged in an artificial intelligence processor, where the artificial intelligence processor also includes an executing circuit for executing a task, and the task scheduler includes: a first sending circuit configured to send a prefetch task of a next task to the executing circuit during an execution of a real task of a current task by the executing circuit, where a task in the task scheduler is split into a prefetch task and a real task that are interrelated; and a second sending circuit configured to send a real task of the next task to the executing circuit after the executing circuit has completed the execution of the prefetch task of the next task, so that the executing circuit executes the real task of the next task after the executing circuit has completed the execution of the real task of the current task.

A second aspect of the present disclosure provides an artificial intelligence processor, including: an executing circuit, which is configured to execute a plurality of tasks; and the task scheduler described in the first aspect, which is configured to interact with the executing circuit, so that the scheduled plurality of tasks are executed by the executing circuit.

A third aspect of the present disclosure provides a board card, including the artificial intelligence processor described in the second aspect.

A fourth aspect of the present disclosure provides a method for executing task scheduling, including: sending a prefetch task of a next task to an executing circuit during an execution of a real task of a current task by the executing circuit, where the task is split into a prefetch task and a real task that are interrelated; and sending a real task of the next task to the executing circuit after the executing circuit has completed the execution of the prefetch task of the next task, so that the executing circuit executes the real task of the next task after the executing circuit has completed the execution of the real task of the current task.

A fifth aspect of the present disclosure provides a device configured to schedule and execute a task, including: a processor; and a memory, on which a program instruction for task scheduling is stored, where when the program instruction is executed by the processor, the above and a plurality of embodiments to be discussed below are executed.

A sixth aspect of the present disclosure provides a computer-readable storage medium, on which a computer program instruction for task scheduling is stored, where when the computer program instruction is executed by a processor, the aforementioned method and a plurality of embodiments to be discussed below are implemented.

By means of the scheme provided in the aforementioned aspects, task scheduling for a dual-threaded architecture with relatively simplified design and stable performance may be realized. Specifically, the present disclosure splits a task into a prefetch task and a real task, and starts to execute a prefetch task of a next task during the execution of a real task of a current task, so that a corresponding prefetch task has been completed before a real task of the next task is executed, thus improving the parallelism and speed of task execution. Furthermore, a processor may reduce thread switching overheads, realize dual-threaded task scheduling, and obtain stable performance benefits by supporting parallel execution of a prefetch task and a real task simultaneously.

### BRIEF DESCRIPTION OF THE DRAWINGS

By reading the following detailed description with reference to drawings, the above-mentioned and other objects, features and technical effects of exemplary implementations of the present disclosure will become easier to understand. In the drawings, several implementations of the present disclosure are shown in an exemplary but not restrictive manner, and the same or corresponding reference numerals indicate the same or corresponding parts.

FIG. 1 is a simplified block diagram of an artificial intelligence processor according to an embodiment of the present disclosure.

FIG. 2 is a detailed structural block diagram of a task scheduler according to an embodiment of the present disclosure.

FIG. 3 is a simplified flowchart of a method for executing task scheduling according to an embodiment of the present disclosure.

FIG. 4 is a flowchart of details of a method for executing task scheduling according to an embodiment of the present disclosure.

FIG. 5 is a schematic flowchart for executing task scheduling according to an embodiment of the present disclosure.

FIG. 6 is a state transition diagram for executing task scheduling according to an embodiment of the present disclosure.

FIG. 7 is a schematic structural diagram of a software and hardware architecture of data stream programming according to an embodiment of the present disclosure.

FIG. 8 is a structural diagram of a board card according to an embodiment of the present disclosure.

FIG. 9 is a structural diagram of a combined processing apparatus according to an embodiment of the present disclosure.

FIG. 10 is a schematic diagram of an internal structure of a computing apparatus according to an embodiment of the present disclosure.

FIG. 11 is a schematic diagram of an internal structure of an intelligent processing unit (IPU) core according to an embodiment of the present disclosure.

FIG. 12 is a schematic diagram of a data writing process between IPU cores of different clusters according to an embodiment of the present disclosure.

### DETAILED DESCRIPTION

Technical solutions in embodiments of the present disclosure will be described clearly and completely hereinafter with reference to drawings in the embodiments of the present disclosure. Obviously, embodiments to be described are merely some of, but not all of the embodiments of the present disclosure. All other embodiments obtained by those skilled in the art based on the embodiments of the present disclosure without creative efforts shall fall within the scope of protection of the present disclosure.

It should be understood that terms such as “first”, “second”, “third”, and “fourth” in the claims, the specification, and the drawings of the present disclosure are used for distinguishing different objects rather than describing a specific order. Terms such as “including” and “comprising” used in the specification and the claims of the present disclosure indicate the presence of a feature, an entity, a step, an operation, an element, and/or a component, but do not exclude the existence or addition of one or more other features, entities, steps, operations, elements, components, and/or collections thereof.

It should also be understood that terms used in the specification of the present disclosure are merely for a purpose of describing a particular embodiment rather than limiting the present disclosure. As being used in the specification and the claims of the present disclosure, unless the context clearly indicates otherwise, singular forms such as “a”, “an”, and “the” are intended to include plural forms. It should also be understood that a term “and/or” used in the specification and the claims of the present disclosure refers to any and all possible combinations of one or more of relevant listed items and includes these combinations.

As being used in the specification and the claims of the present disclosure, a term “if” may be interpreted as “when”, or “once” or “in response to a determination” or “in response to a case where something is detected” depending on the context. Similarly, depending on the context, a clause “if it is determined that” or “if [a described condition or event] is detected” may be interpreted as “once it is determined that”, or “in response to a determination”, or “once [a described condition or event] is detected”, or “in response to a case where [a described condition or event] is detected”.

As mentioned above, in order to achieve efficient task scheduling and execution, the disclosed scheme proposes a dual-threading mechanism. Specifically, by abstractly dividing a task run by a processor into a prefetch task and a real task and completing a prefetch task of a next task during an execution of a real task of a current task, “pseudo-” dual-threading task scheduling may be achieved. Therefore, the disclosed scheme may realize a parallel execution of the current task and the next task to a certain extent, so as to improve the speed and efficiency of task execution and reduce the thread switching overhead and the complexity of control logic.

Specific implementations of the present disclosure will be described in detail in combination with drawings below.

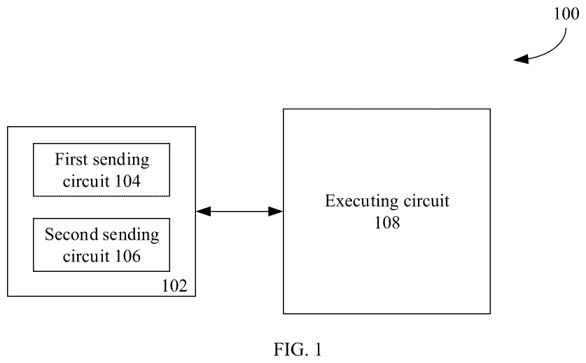

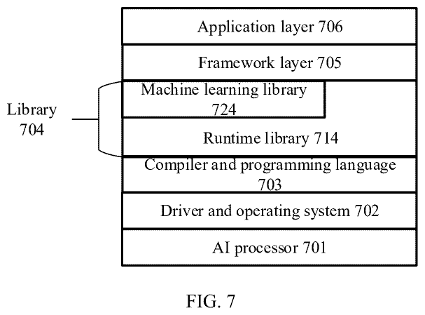

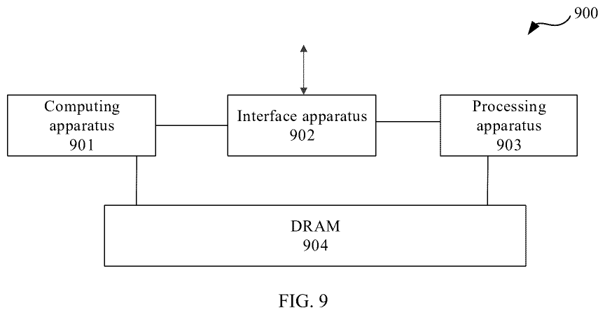

FIG. 1 is a simplified block diagram of an artificial intelligence (AI) processor 100 according to an embodiment of the present disclosure. It may be understood that the AI processor here may be an AI processor 701 described below in combination with FIG. 7 or a computing apparatus 901 shown in FIG. 9, and has one or more intelligent processing unit (IPU) cores, so that multiple tasks may be performed in parallel.

As shown in FIG. 1, the AI processor 100 may include a task scheduler 102 and an executing circuit 108. Here, the task scheduler may receive one or more tasks from an upper layer of a computing platform, and send the one or more tasks to the executing circuit 108 for execution. In some scenarios, task flows (each of which may include one or more tasks) from different users may be sent by the task scheduler for execution. Depending on the context of the present disclosure, the executing circuit 108 here may be an arithmetic unit (or a computing core) in the artificial intelligence processor, and may cooperate with the task scheduler to implement the execution of the sent task. Although only one executing circuit 108 is shown in FIG. 1, it may be understood by those skilled in the art that the executing circuit 108 of the present disclosure is not limited to one. In an implementation scenario, the AI processor 100 of the present disclosure may also include a plurality of executing circuits 108 for the smooth execution of the task.

In a scenario, the task scheduler of the present disclosure may include a first sending circuit 104 and a second sending circuit 106. Specifically, the first sending circuit is configured to send a prefetch task of a next task to the executing circuit during an execution of a real task of a current task by the executing circuit, where a task in the task scheduler is split into a prefetch task and a real task that are interrelated. Accordingly, the second sending circuit is configured to send a real task of the next task to the executing circuit after the executing circuit has completed the execution of the prefetch task of the next task, so that the executing circuit executes the real task of the next task after the executing circuit has completed the execution of the real task of the current task.

In the context of the present disclosure, the executing circuit performs multiple tasks. In order to facilitate description, a task that is about to be executed by the executing circuit in the multiple tasks is called a current task, and a task immediately following the current task is called a next task. It may be understood by those skilled in the art that, after the execution of the current task has been completed by the executing circuit, the aforementioned next task is transformed into the current task to be executed by the executing circuit, and the subsequent task is transformed into the next task.

As mentioned earlier, in order to implement a dual-threading task scheduling mechanism, the present disclosure abstracts the task by the executing circuit into two classes of tasks, one is a task that is really running (exe task), and the other is a task that serves the really running task (prefetch task). In the present disclosure, the former is called a real task, while the next is called a prefetch task. Thus, the present disclosure splits a task by the executing circuit into two parts, including a prefetch task and a real task.

The prefetch task and the real task, as the two parts of the task, may be split in different ways. As an example, by using a program instruction, a task may be split into a prefetch task and a real task that are interrelated, where the prefetch task and the real task may be set to have the same identification bit to indicate the relevance between them. Alternatively, the task scheduler of the present disclosure may be provided with a functional module or a circuit dedicated to task splitting, so as to split the task into the prefetch task and the real task. In an implementation scenario, the prefetch task and the real task may have a common task identifier to indicate that the two are interrelated and constitute a complete task.

In some scenarios, when a task includes execution steps such as fetching an instruction, querying a translation lookaside buffer (TLB), translating a virtual address to a physical address (for example, querying a page table to find address mapping relationships), and executing, the present disclosure classifies fetching the instruction, querying the TLB, querying the page table (including parameter loading) as steps to be executed during the execution of the prefetch task, and the executing step as the real task. In some scenarios, when a TLB stored on an on-chip memory such as a static random access memory (SRAM) may be utilized to complete address translation, an operation such as querying a page table on an off-chip dynamic random access memory (DRAM) may not be performed. By scheduling and executing a corresponding prefetch task before a real task is executed, operations such as fetching an instruction and querying may be omitted when the real task is executed, thus improving the speed of task execution and realizing the parallel execution of two types of tasks.

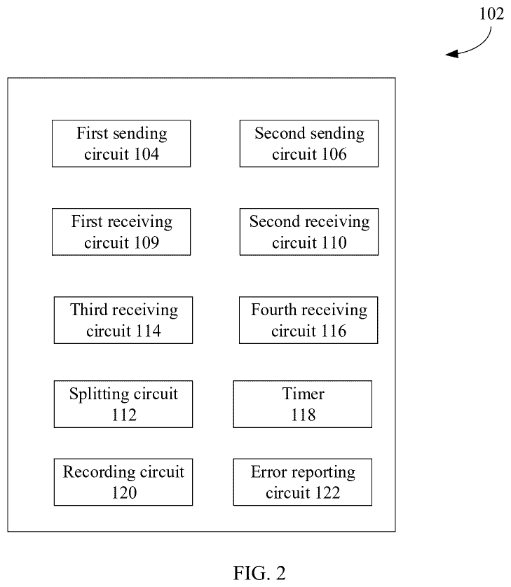

FIG. 2 is a detailed structural block diagram of a task scheduler according to an embodiment of the present disclosure. It should be understood that the task scheduler shown in FIG. 2 may be seen as an implementation of the task scheduler shown in FIG. 1, so the description of FIG. 1 applies equally to FIG. 2.

As shown in FIG. 2, the task scheduler 102 of the present disclosure includes a first sending circuit 104 and a second sending circuit 106. The main functions of the two sending circuits have been described in combination with FIG. 1, and will not be repeated here.

In an embodiment, the task scheduler 102 also includes a first receiving circuit 109 configured to receive a task that is split by a program instruction into a prefetch task and a real task that are interrelated. As mentioned earlier, the program instruction here may be a code instruction artificially written by a programmer or user, and the execution of the code instruction enables a task to be split into a prefetch task and a real task. For example, some tasks such as fetching an instruction, querying an address, and substituting a parameter may be attributed to the prefetch task, and the remaining to-be-executed parts of the task may be attributed to the real task. Additionally or alternatively, the task scheduler 102 may also include a splitting circuit 112 configured to split the received task into a prefetch task and a real task that are interrelated. In other words, the task scheduler 102 of the present disclosure may actively split a task into a prefetch task and a real task.

In order to realize the parallel execution of the task, the second sending circuit 106 in the task scheduler 102 may be configured to send a prefetch task of a next task to an executing circuit at a predetermined time before the execution of the real task of the current task is completed, so that the executing circuit executes the prefetch task of the next task during the execution of the real task of the current task by the executing circuit. By executing the prefetch task of the next task simultaneously during the execution of the real task of the current task, the scheme of the present disclosure realizes the parallel task execution under the dual-threading mechanism.

As previously mentioned, the prefetch task of the present disclosure may include translating a virtual address to a physical address, and as an implementation, the aforementioned address translation may be implemented by a page table query, where the page table may typically be stored on the off-chip dynamic random access memory. Based on this, the aforementioned predetermined time may be determined based on the number of levels of the page table of the page table query and the delay of the page table at each level. For example, when the page table has four levels and the query time for each level of the page table is 500 nanoseconds (“ns”), the predetermined time of the present disclosure may be determined to be 4×500 ns=2 us (“microseconds”).

In an implementation scenario, the task scheduler 102 may also include a second receiving circuit 110 configured to receive a pre-finish indication of the real task of the current task from the executing circuit. In response to receiving the pre-finish indication, the first sending circuit 104 may send the prefetch task of the next task to the executing circuit, so that the executing circuit releases hardware resources for the execution of the prefetch task of the next task.

In order to monitor the execution of the real task, the task scheduler may also include a third receiving circuit 114 and a timer (or called a timing circuit) 118. In operation, the third receiving circuit 114 may be configured to receive a finish indication of the prefetch task of the next task from the executing circuit 108. In response to receiving the finish indication of the prefetch task of the next task from the executing circuit 108, the timer 118 may be started to time the execution of the real task of the current task by the executing circuit. In a scenario, in response to a case where the aforementioned timing of the timer 118 exceeds a preset threshold and the third receiving circuit 114 does not receive the finish indication of the prefetch task of the next task from the executing circuit 108, at this time, the first sending circuit 104 may re-send the prefetch task of the next task to the executing circuit 108 for re-execution. Alternatively, the first sending circuit 104 may also send the prefetch task of the next task to another executing circuit different from the executing circuit 108, so that the execution of the prefetch task of the next task is completed by another executing circuit.

To ensure that the re-sent prefetch task may be executed as soon as possible, the task scheduler may also be provided with a sending queue configured to preferentially send a task. In this situation, when the timing of the timer exceeds the preset threshold and no indication is received from the executing circuit 108, the task scheduler 102 may place the prefetch task of the next task into a priority sending queue, so that the prefetch task of the next task may be re-sent to the executing circuit 108 or another executing circuit with the highest sending permission.

In order to realize the monitoring and reporting of task execution, the task scheduler of the present disclosure may also be provided with a recording circuit 120 and an error reporting circuit 122. In an implementation scenario, the recording circuit may be configured to record an error that occurs during the execution of the prefetch task. The error, for example, may be an error indicating that the pre-finish indication from the executing circuit 108 has not been received, or various error messages that are fed back by the executing circuit 108 during execution. After that, the error reporting circuit 122 may report the error recorded by the recording circuit to an upper-layer user, so that the upper-layer user takes appropriate measures for the execution error of the prefetch task. In a scenario, the error reporting circuit 122 may report an error when the real task that is interrelated with the prefetch task is executed. Through such error reporting, the user instructs the executing circuit 108 to perform error correction on the error during the execution of the real task, so as to complete the execution of the entire task. In addition, when the consequences caused by the incorrect execution of the prefetch task may not be overcome, the executing circuit may also feed back to the task scheduler, so that the task scheduler re-sends the prefetch task with the execution error for execution or re-sends the prefetch task with the execution error to another executing circuit for execution.

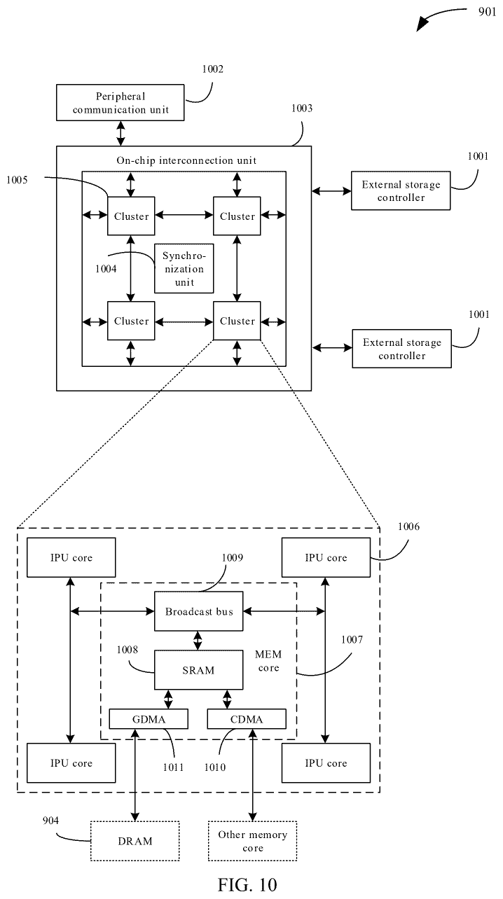

In a scenario, when the executing circuit 108 acts as a processing unit (such as a cluster 1005 shown in FIG. 10) in an artificial intelligence processor, the executing circuit 108 may include multiple IPU cores (such as IPU cores 1006 shown in FIG. 10) operating on parallel execution tasks. In this situation, a task of the present disclosure may be split into multiple sub-tasks, and each sub-task may include a prefetch sub-task and a real sub-task that are interrelated. Similar to the previous description, the prefetch sub-task here may include tasks such as instruction fetching and address translation operations, and the real sub-task may be a specific real task execution.

Based on the sub-task splitting described above, the task scheduler 102 of the present disclosure may also be configured to interact with the multiple IPU cores, so that the multiple IPU cores execute prefetch sub-tasks and real sub-tasks of corresponding sub-tasks in parallel. In the process of interacting with the multiple IPU cores to execute the tasks, the first sending circuit may also be configured to send a corresponding prefetch sub-task of a next task to each of the multiple IPU cores in response to receiving a pre-finish indication of a prefetch sub-task of a current task from all the multiple IPU cores. Accordingly, the second sending circuit may also be configured to send a corresponding real sub-task of the next task to each of the multiple IPU cores for execution in parallel by the multiple IPU cores in response to receiving a finish indication of a real sub-task of the current task and the pre-finish indication of the prefetch sub-task of the next task from all the multiple IPU cores. In the scheme of the present disclosure, when receiving the pre-finish indication, the task scheduler may release computing resources of corresponding IPU cores, so that the task scheduler may flexibly schedule tasks according to the resource occupation of the multiple IPU cores.

The details of the composition of the task scheduler in this disclosed embodiment are described in combination with FIG. 2 above. Based on the above description, it may be understood by those skilled in the art that the task scheduler of the present disclosure may be implemented in a variety of ways and is not limited to the multiple circuits shown in FIG. 2. Further, although the components of the task scheduler of the present disclosure are shown in the form of circuit modules in FIG. 2, the implementation of the task scheduler of the present disclosure is not limited to the form shown in FIG. 2. Based on the teachings of the present disclosure, those skilled in the art may also think that the task scheduler of the present disclosure may also be implemented in other forms, such as through software or a combination of software and hardware. When the task scheduler is implemented by software, various circuits shown in FIG. 2 may be correspondingly replaced by various program modules or units. By using the task scheduler of the present disclosure, simplified dual-threading task scheduling may be realized, thereby realizing parallelism between threads with low design complexity.

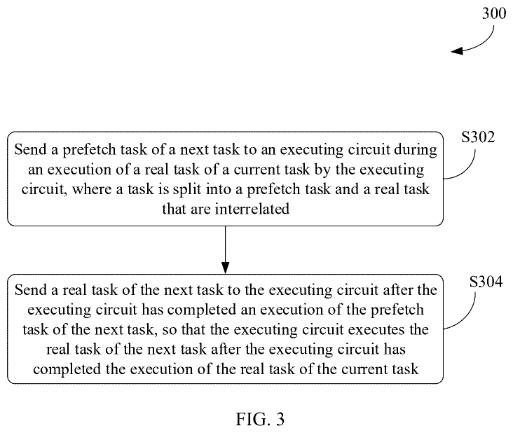

FIG. 3 is a simplified flowchart of a method 300 for executing task scheduling according to an embodiment of the present disclosure. Based on the foregoing descriptions in combination with FIG. 1 and FIG. 2, it may be understood by those skilled in the art that the method 300 may be executed by the task scheduler of the present disclosure, thereby realizing parallelism of task execution with minimal thread switching cost.

As shown in FIG. 3, in step S302, a prefetch task of a next task is sent to an executing circuit during an execution of a real task of a current task by the executing circuit, where a task is split into a prefetch task and a real task that are interrelated. Next, in step S304, a real task of the next task is sent to the executing circuit after the executing circuit has completed an execution of the prefetch task of the next task, so that the executing circuit executes the real task of the next task after the executing circuit has completed the execution of the real task of the current task. As mentioned earlier, the prefetch task and the real task here may be split by software instructions written by a user or programmer, or directly by the task scheduler of the present disclosure. In addition, the relevance between the prefetch task and the real task belonging to the same task may be established through a task identifier, so that the prefetch task and the real task of the same task are completed by the same executing circuit.

It may be seen that by performing the method steps shown in FIG. 3, the task scheduler of the present disclosure innovatively realizes dual-threading task scheduling and highly parallelized task processing by executing the prefetch task of the next task during the execution of the real task of the current task and executing the real task of the next task after the execution of the real task of the current task is completed.

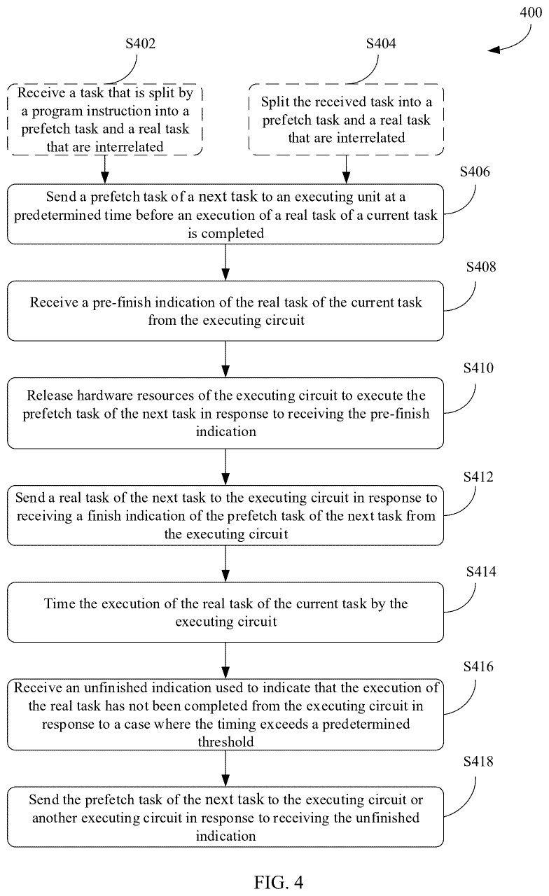

FIG. 4 is a flowchart of details of a method 400 for executing task scheduling according to an embodiment of the present disclosure. It may be understood that the method 400 shows more of the implementation steps and details of the method 300, so the description of the method 300 applies equally to the method steps in FIG. 4. In addition, since the method 400 may also be executed by the task scheduler, the above description of the task scheduler in combination with FIG. 1 to FIG. 3 is also applicable to the description below in combination with FIG. 4, and the same content will not be elaborated.

As shown in FIG. 4, in step S402, a task that is split by a program instruction into a prefetch task and a real task that are interrelated is received. Alternatively, in step S404, the received task is split into a prefetch task and a real task that are interrelated. The task here may be any task performed by an executing circuit, such as tensor-based computing tasks, including, for example, a convolution operation task. As mentioned earlier, the task here may be one of many tasks in one or more task flows. Assuming that the task is a current task to be executed by the executing circuit at present, a task that follows the current task is also a next task.

Then, in step S406, a prefetch task of a next task is sent to an executing unit at a predetermined time before an execution of a real task of a current task is completed. Thereafter, in step S408, a pre-finish indication (“Pre finish”) of the real task of the current task from the executing circuit is received. In step S410, hardware resources of the executing circuit are released to execute the prefetch task of the next task in response to receiving the pre-finish indication.

In step S412, a real task of the next task is sent to the executing circuit in response to receiving a finish indication of the prefetch task of the next task from the executing circuit. As an optional step, in step S414, the execution of the real task of the current task by the executing circuit may be timed, for example by using the timer shown in FIG. 2, and a predetermined threshold may be determined for the timing. An unfinished indication used to indicate that the execution of the real task has not been completed may be received from the executing circuit in response to a case where the timing exceeds the predetermined threshold. Thereafter, the prefetch task of the next task may be sent to the executing circuit or another executing circuit in response to receiving the unfinished indication. In other words, since the real task of the current task is not completed in the scheduled time, the scheme of the present disclosure chooses to re-send the prefetch task of the next task, so that the executing circuit has enough time to complete the real task of the current task. Alternatively, the prefetch task of the next task may also be sent to another executing circuit when the unfinished indication is received. This is especially beneficial for scenarios with multiple executing circuits. By sending the prefetch task of the next task to another executing circuit, the parallel scheduling of the present disclosure is not affected by the execution speed of one executing circuit, but may maximize the advantages of the multiple executing circuits.

The implementation scheme and scenario of the scheme of the present disclosure have been described in combination with FIG. 4 above, and the implementation form and scenario of the scheme of the present disclosure are not limited to this. For example, when the executing circuit completes the real task of the current task within the predetermined threshold for the timing of the timer, at this time, the task scheduler may send the real task of the next task directly to the executing circuit. In other words, the executing circuit at this time has completed the execution of the real task of the current task, and has been temporarily idle and may perform the real task of the next task.

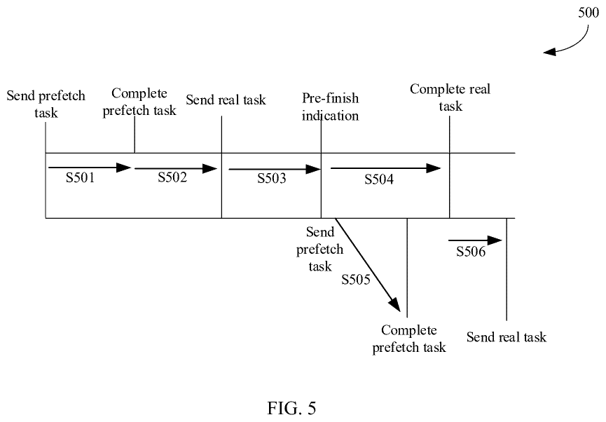

FIG. 5 is a schematic flowchart for executing task scheduling 500 according to an embodiment of the present disclosure. It may be seen that in order to further understand the scheduling scheme of the present disclosure, FIG. 5 shows a processing flow of the task scheduler of the present disclosure in a manner similar to a sequence chart. Since the operation details of the task scheduler of the present disclosure have previously been described in detail in combination with FIG. 1 to FIG. 4, the same or similar technical content will be shown in a concise manner below.

As shown in FIG. 5, in step S501, shown along the arrow, the task scheduler of the present disclosure may send a prefetch task of a current task to an executing circuit. Then, after the executing circuit has completed the execution of the prefetch task, in step S502, shown along the arrow, the task scheduler may send a real task to the executing circuit. Thereafter, at the predetermined time described above, in step S503, shown along the arrow, the task scheduler may receive a pre-finish indication from the executing circuit. Thereafter, in step S504, shown along the arrow, during the execution of the real task of the current task by the executing circuit, the task scheduler sends the prefetch task of the next task to the executing circuit from the moment the task scheduler receives the pre-finish indication, and the prefetch task is completed by the executing circuit.

As can be seen from the figure, in order to ensure that the executing circuit may successfully complete the real task of the current task, although the prefetch task of the next task has been completed, the real task of the next task is not sent until the real task of the current task is completed, which is shown by the arrow end of the arrow S504. In response to a case where the execution of the real task of the current task has been completed, such as receiving a finish indication used to indicate that the real task has been completed from the executing circuit, the task scheduler may send the real task of the next task to the executing circuit along the S506 shown by the arrow, so that the executing circuit may then execute the real task of the next task. Although not shown further in the figure, it may be understood by those skilled in the art, based on the detailed description above, that for more than two or more tasks, the processing flow may be executed in a similar manner as shown repeatedly until the scheduled execution of all tasks is completed. For example, during the execution of the real task of the next task, the task scheduler may send a prefetch task of a task following after the next task to the executing circuit for execution by the executing circuit. By analogy, the task scheduler of the present disclosure finally sends all task scheduling to the executing circuit for execution.

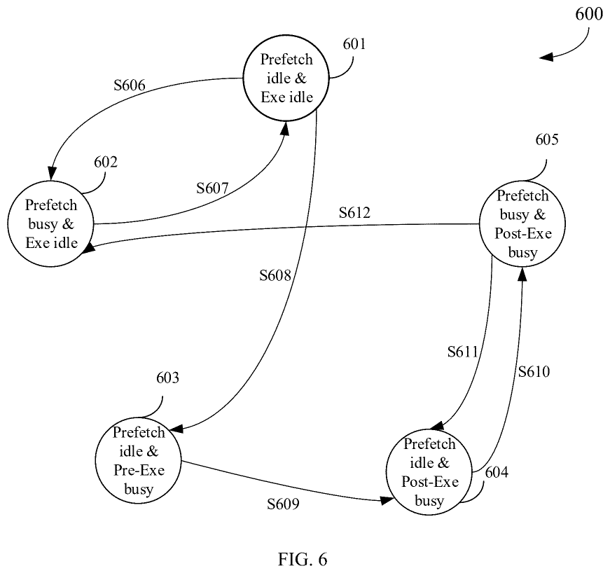

FIG. 6 is a state transition diagram for executing task scheduling 600 according to an embodiment of the present disclosure. It may be understood that the state transition diagram in FIG. 6 is only illustrative, and based on the previous description, those skilled in the art may understand that the task scheduling scheme of the present disclosure also has state transitions not shown in the diagram. In addition, the previous description of the operation of the task scheduler in combination with FIG. 1 to FIG. 5 also applies to FIG. 6, and the same content will be described in a simplified manner rather than repeated.

As shown in the figure, at the beginning of task scheduling, which is a state node 601 in the figure, both the executions of a prefetch task (as shown by “Prefetch” in the figure) and a real task (Exe) are idle. Then, as shown by the arrow S606, when the task scheduler sends the prefetch task of the current task to the executing circuit, at this time, the state transitions to a state node 602. At this state node, the execution of the prefetch task of the current task is busy but the execution of the real task is idle since the real task has not been sent by the task scheduler to the executing circuit at this time. Then, after the executing circuit completes the execution of the prefetch task of the current task, the state transitions back to the state node 601 as shown by the arrow S607. At this state node, the executions of the prefetch task and the real task of the current task are idle again since the execution of the prefetch task has been completed.

According to the scheme of the present disclosure, the task scheduler may then send the real task of the current task to the executing circuit, as shown by the arrow S608. In this case, the state transitions from the state node 601 to a state node 603. At the state node 603, the execution of the prefetch task of the current task remains idle while the pre-execution (as shown by “Pre-Exe” in the figure) of the real task is busy. Here, the pre-execution may be used to represent the execution of the real task of the current task by the executing circuit before the predetermined time mentioned above.

Then, as the executing circuit executes the real task of the current task, the state transitions from the state node 603 to a state node 604 as shown by the arrow S609. In this state transition, since the prefetch task of the current task has been completed, the execution of the prefetch task is still idle, while the execution of the real task enters a busy state of a final stage from the predetermined time above; in other words, the post-execution (as shown by “Post-Exe” in the figure) of the real task of the current task is still in progress. The task scheduler then sends the prefetch task of the next task to the executing circuit. Thus, the state transitions from the state node 604 to a state node 605 as shown by the arrow S610. In this state transition, since the executing unit executes the prefetch task of the next task, at this time, the execution of the prefetch task of the next task changes to a busy state. At the same time, since the post-execution of the real task of the current task by the executing circuit is still in progress, the post-execution is still busy.

Thus, the state transitions from the state node 605 to the state node 604 as shown by the arrow S611. As mentioned above, in this state transition, the execution of the prefetch task is idle since the executing circuit has completed the execution of the prefetch task of the next task. At this time, since the executing circuit is still in the post-execution of the real task of the current task, the post-execution is still busy. When the executing circuit completes the post-execution of the real task of the current task at the state node 605, as shown by the arrow S612, the executing circuit sends the finish indication of the real task to the task scheduler, so that the execution of the real task changes to an idle state at the state node 602.

The state transition of the task scheduler in performing parallel scheduling has been described above by example in combination with FIG. 6. It may be understood that the description here is only exemplary but not restrictive. Those skilled in the art may also add the error state mentioned above based on the description here. The error may be an execution error of a prefetch task or a real task. Thus, the above states may also include, for example, a state where the execution of the prefetch task is idle and the execution of the real task has an error, or a state where the execution of the real task is busy and the execution of the prefetch task has an error. In this scenario, the AI processor of the present disclosure may also be provided with a control circuit, which is connected to the executing circuit and collects error information about the task execution from the executing circuit to notify the task scheduler. In some situations, for an execution error, a task with the execution error may be rescheduled, the code of the task may be modified by the user, or the execution circuit may be restarted by the user.

FIG. 7 is a design drawing of a hardware and software architecture according to an embodiment of the present disclosure. As can be seen from the figure, the hardware and software architecture in this embodiment may include an AI processor 701, a driver and operating system 702, a compiler and programming language 703, a library 704, a framework layer 705, and an application layer 706. It may be understood that the hardware and software architecture here may be applied to an artificial intelligence computing system or computing platform in this application.

Specifically, the AI processor 701 (which may, for example, be included in the board card described below in combination with the accompanying figure) considers both computing optimization and data moving optimization in the hardware design. To this end, the AI processor 701 uses a customized computing unit to speed up computing, and uses on-chip storage to speed up data moving, thereby obtaining extremely high performance and energy efficiency. In addition, in order to support various algorithmic optimizations, the AI processor 701 may be provided with a customized computing unit and an instruction set, where the instruction set may provide computing instructions of different granularity (including scalar, vector, and/or matrix). Further, when many factors such as algorithm access characteristics, hardware cost, verification difficulty are considered, on-chip storage may be adopted, and data moving may be optimized. In practice, the AI processor of the present disclosure may achieve speeds tens of times greater than a mainstream graphics processing unit (GPU).

The driver and operating system 702 is mainly responsible for task scheduling on the AI processor 701. For example, the scheduling operation may realize scheduling according to task priority, communication and synchronization among multiple devices. The compiled program may implement the scheduling and execution of a to-be-executed task on a specific processor through the operating system and driver, including but not limited to the following operations: allocating and releasing device memory, implementing data transmission between devices, maintaining a task queue, scheduling tasks according to priorities, and realizing synchronization and collaboration among multiple devices.

The compiler and programming language 703 may be a set of assembly languages developed for the instruction set of the AI processor 701. In application, the compiler and programming language 703 may translate deep learning operators developed for the AI processor 701 into a combination of processor instructions to easily call the AI processor 701, so that the AI processor 701 may be used efficiently. In some application scenarios, the compilation may be optimized by performing the intermediate expression phase of the compilation by using the compiler.

The library 704 may include a runtime library 714 and a machine learning library 724. In an implementation scenario, the aforementioned library 704 may use the instruction set of the AI processor 701 and may be partially optimized according to the instruction set of the AI processor 701 to increase the running speed of the operator. The runtime library 714 may be a high-performance operator library specifically developed for the AI processor 701, and may be configured to complete the interaction between the general-purpose processor and the AI processor. Further, the runtime library 714 may also provide a set of interfaces for the AI processor. The machine learning library 724 may be configured to accelerate various machine learning or deep learning algorithms on the AI processor. Specifically, the machine learning library 724 may provide a set of efficient, general, flexible and extensible programming interfaces. Upper-layer machine learning applications may be directly programmed using programming interfaces of various programming frameworks (such as pytorch, TensorFlow, Caffe, MXNet, and the like) or interfaces provided by the machine learning library 724. In addition, the machine learning library 724 of the present disclosure may facilitate the call of the hardware platform, and the runtime library 714 may realize some basic common operators, such as convolution, pooling and other operations.

The framework layer 705 may increase the encapsulation of the operator developed for the AI processor, especially the encapsulation of an operator from the runtime library 714. In addition, the framework layer 705 may also modify related task scheduling or memory management. In an application scenario, the framework layer 705 may adopt the architecture of TensorFlow and the like.

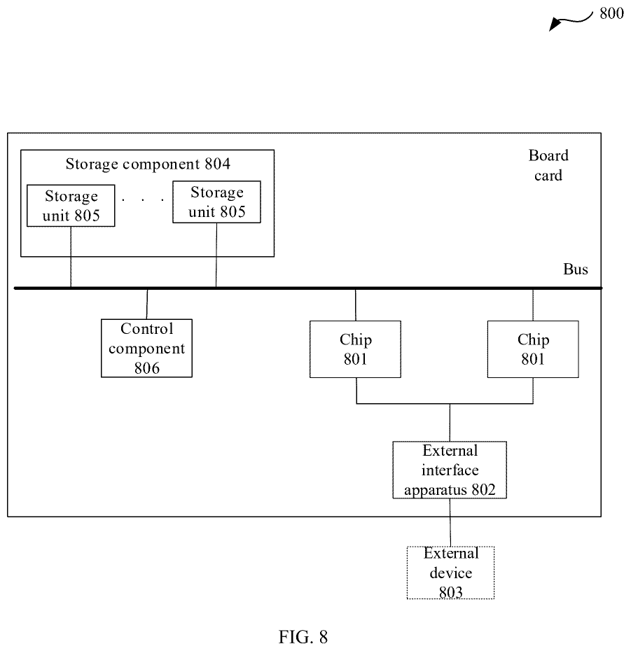

The device of the embodiment of the present disclosure may be an artificial intelligence chip or board card, and the like. FIG. 8 is a structural diagram of a board card 800 according to an embodiment of the present disclosure. As shown in FIG. 8, the board card 800 includes a chip

(or called processing chip) 801, which is a system on chip (SoC), or called an on-chip system, and integrates one or more combined processing apparatuses. The combined processing apparatus is an AI computing unit, which is configured to support various deep learning algorithms and various machine learning algorithms and meet requirements of intelligent processing in complex scenarios in computer vision, speech, natural language processing, data mining, and other fields. In particular, deep learning technology is widely applied in the field of cloud intelligence. A prominent feature of cloud intelligence applications is a large amount of input data, which has high requirements for storage capacity and computing power of a platform. The board card 800 of this embodiment is suitable for cloud intelligent applications and has huge off-chip storage, huge on-chip storage, and a large amount of computing power.

The chip 801 is connected to an external device 803 through an external interface apparatus 802. The external device 803 may be, for example, a server, a computer, a camera, a monitor, a mouse, a keyboard, a network card, or a WIFI interface. To-be-processed data may be transferred from the external device 803 to the chip 801 through the external interface apparatus 802. A computing result of the chip 801 may be transferred back to the external device 803 through the external interface apparatus 802. According to different application scenarios, the external interface apparatus 802 may have different interface forms, such as a peripheral component interface express (PCIe) interface, and the like. The board card 800 further includes a storage component 804 configured to store data.

The storage component 804 includes one or more storage units 805. The storage component 804 is connected to and transfers data to a control component 806 and the chip 801 through a bus. The control component 806 in the board card 800 is configured to regulate and control a state of the chip 801. As such, in an application scenario, the control component 806 may include a micro controller unit (MCU). In the application scenario of the scheduling scheme of the present disclosure, the control component may run a drive program and include a scheduler. When the aforementioned driver program is controlled and run by the control component, the task scheduler executes the operation flow described in combination with FIG. 1 to FIG. 6, and then sends the task to the processing chip or IPU core for execution.

FIG. 9 is a structural diagram of a combined processing apparatus 900 in the chip 801 of this embodiment. As shown in FIG. 9, the combined processing apparatus 900 includes a computing apparatus 901, an interface apparatus 902, a processing apparatus 903, and a dynamic random access memory (DRAM) 904.

The computing apparatus 901 is configured to perform an operation specified by a user. The computing apparatus 901 is mainly implemented as a single-core intelligent processor or a multi-core intelligent processor and is configured to perform deep learning computing or machine learning computing. The computing apparatus 901 interacts with the processing apparatus 903 through the interface apparatus 902 to jointly complete an operation specified by a user.

The interface apparatus 902 is configured to transfer data and control instructions between the computing apparatus 901 and the processing apparatus 903. For example, the computing apparatus 901 may acquire input data from the processing apparatus 903 via the interface apparatus 902 and write the input data to an on-chip storage apparatus of the computing apparatus 901. Further, the computing apparatus 901 may acquire control instructions from the processing apparatus 903 via the interface apparatus 902 and write the control instructions to an on-chip control cache of the computing apparatus 901. Alternatively or optionally, the interface apparatus 902 may further read data in the storage apparatus of the computing apparatus 901 and then transfer the data to the processing apparatus 903.

The processing apparatus 903 serves as a general processing apparatus and performs basic controls including, but not limited to, moving data, starting and/or stopping the computing apparatus 901. According to different implementations, the processing apparatus 903 may be a central processing unit (CPU), a graphics processing unit (GPU), or one or more of other general and/or dedicated processors. These processors include, but are not limited to, a digital signal processor (DSP), an ASIC, a field-programmable gate array (FPGA), or other programmable logic components, discrete gate or transistor logic components, discrete hardware components, and the like. Moreover, the number of the processors may be determined according to actual requirements. As described above, with respect to the computing apparatus 901 of the present disclosure only, the computing apparatus 901 of the present disclosure may be viewed as having a single-core structure or an isomorphic multi-core structure. However, when considered together, the computing apparatus 901 and the processing apparatus 903 are viewed as forming a heterogeneous multi-core structure.

The DRAM 904 is configured to store to-be-processed data. The DRAM 904 is a double data rate (DDR) memory with a size of 16G or more than 16G generally. The DRAM 904 is configured to save data of the computing apparatus 901 and/or the processing apparatus 903.

FIG. 10 is a schematic diagram of an internal structure of the computing apparatus 901. The computing apparatus 901 is configured to process input data in computer vision, speech, natural language, and data mining. The computing apparatus 901 in the figure is designed in a multi-core hierarchical structure. The computing apparatus 901 serves as an on-chip system and includes a plurality of clusters, where each cluster further includes a plurality of IPU cores configured to execute the tasks delivered in the present disclosure. In other words, the computing apparatus 901 is composed of an SoC-cluster-IPU core hierarchy.

In terms of a hierarchy of the on-chip system, as shown in FIG. 10, the computing apparatus 901 includes an external storage controller 1001, a peripheral communication unit 1002, an on-chip interconnection unit 1003, a synchronization unit 1004, and a plurality of clusters 1005.

There may be a plurality of external storage controllers 1001, two of which are exemplified in the figure. The external storage controllers are configured to, in response to access requests from the IPU cores, access an external storage device, such as the DRAM 904 in FIG. 9, to read or write data off-chip. The peripheral communication unit 1002 is configured to receive a control signal from the processing apparatus 903 through the interface apparatus 902 to start the computing apparatus 901 to perform a task, such as the prefetch task and the real task mentioned above in the present disclosure. The on-chip interconnection unit 1003 connects the external storage controller 1001, the peripheral communication unit 1002, and the plurality of clusters 1005 and is configured to transfer data and control signals among the units. The synchronization unit 1004 is a global barrier controller (GBC) and is configured to coordinate a work progress of each cluster to ensure synchronization of information. The plurality of clusters 1005 are computing cores of the computing apparatus 901, four of which are illustrated in the figure. With the development of hardware, the computing apparatus 901 of the present disclosure may further include 8, 16, 64, or even more clusters 1005.

In terms of a hierarchy of the clusters, as shown in FIG. 10, each cluster 1005 includes a plurality of IPU cores 1006 and a memory core (MEM core) 1007.

Four IPU cores 1006 are illustrated in the figure. The present disclosure does not limit the number of the IPU cores 1006. An internal architecture of the IPU core 1006 is shown in FIG. 10. Each IPU core 1006 includes three units: a control unit 91, an operation unit 92, and a storage unit 93.

The control unit 91 is configured to coordinate and control work of the operation unit 92 and the storage unit 93 to complete a deep learning task. The control unit 91 includes an instruction fetch unit (IFU) 1111 and an instruction decode unit (IDU) 1112. The IFU 1111 is configured to acquire an instruction from the processing apparatus 903. The IDU 1112 is configured to decode the instruction acquired and send a decoding result as control information to the operation unit 92 and the storage unit 93. The instruction fetching and instruction decoding operations herein may be regarded as the prefetch tasks of the present disclosure.

The operation unit 92 includes a vector operation unit 1121 and a matrix operation unit 1122. The vector operation unit 1121 is configured to perform a vector operation and supports complex operations such as vector multiplication, addition, and nonlinear conversion. The matrix operation unit 1122 is responsible for core computing of deep learning algorithms, such as matrix multiplication and convolution.

The storage unit 93 is configured to store or move related data. The storage unit 93 includes a neuron random access memory (NRAM) 1131, a weight RAM (WRAM) 1132, an input/output direct memory access (IODMA) unit 1133, and a move direct memory access (MVDMA) unit 1134. The NRAM 1131 is configured to store input and output data and intermediate results for computing by the IPU cores 1006 calculations. The WRAM 1132 is configured to store a weight of a deep learning network. The IODMA 1133 controls memory accesses of the NRAM 1131/the WRAM 1132 and the DRAM 904 through a broadcast bus 1009. The MVDMA 1134 is configured to control memory accesses of the NRAM 1131/the WRAM 1132 and a shared RAM (SRAM) 1008.

Going back to FIG. 10, the memory core 1007 is mainly used for storage and communication. In other words, the memory core 1007 is mainly used for storing shared data or intermediate results between the IPU cores 1006 and performing communications between the clusters 1005 and the DRAM 904, communications between the clusters 1005, and communications between the IPU cores 1006. In other embodiments, the memory core 1007 is capable of performing a scalar operation and is configured to perform the scalar operation.

The memory core 1007 includes the SRAM 1008, the broadcast bus 1009, a cluster direct memory access (CDMA) unit 1010, and a global direct memory access (GDMA) unit 1011. The SRAM 1008 plays the role of a data transfer station with high performance. Data reused among different IPU cores 1006 in the same cluster 1005 is not required to be acquired from the DRAM 904 separately through the IPU cores 1006. Instead, the data is transferred among the IPU cores 1006 through the SRAM 1008. The memory core 1007 is only required to quickly distribute the reused data from the SRAM 1008 to the plurality of IPU cores 1006, so as to improve inter-core communication efficiency and greatly reduce on-chip and off-chip input/output accesses.

The broadcast bus 1009, the CDMA 1010, and the GDMA 1011 are used for performing the communication between the IPU cores 1006, the communication between the clusters 1005, and data transfer between the clusters 1005 and the DRAM 904, respectively. The above will be explained separately below.

The broadcast bus 1009 is used for completing high-speed communication between the IPU cores 1006 in the clusters 1005. The broadcast bus 1009 of this embodiment supports inter-core communication modes including unicast, multicast, and broadcast. The unicast refers to point-to-point (single IPU core-to-single IPU core) data transfer. The multicast refers to a communication mode for transferring one copy of data from the SRAM 1008 to a certain number of IPU cores 1006. The broadcast refers to a communication mode for transferring one copy of data from the SRAM 1008 to all IPU cores 1006. The broadcast is a special case of the multicast.

The CDMA 1010 is configured to control memory access of the SRAM 1008 among different clusters 1005 in the same computing apparatus 901. FIG. 12 is a schematic diagram that an IPU core intends to write data to an IPU core of another cluster to illustrate a working principle of the CDMA 1010. In this application scenario, the same computing apparatus includes a plurality of clusters. For the convenience of illustration, only a cluster 0 and a cluster 1 are shown in the figure. The cluster 0 and the cluster 1 include a plurality of IPU cores, respectively. Similarly, for the convenience of illustration, the cluster 0 in the figure shows only an IPU core 0, and the cluster 1 in the figure shows only an IPU core 1. The IPU core 0 intends to write data to the IPU core 1.

First, the IPU core 0 sends a unicast write request to write the data to a local SRAM 0. A CDMA 0 serves as a master terminal, and a CDMA 1 serves as a slave terminal. The master terminal sends the write request to the slave terminal. In other words, the master terminal sends a write address AW and write data W and sends the data to an SRAM 1 of the cluster 1. Next, the slave terminal sends a write response B in response. Finally, the IPU core 1 of the cluster 1 sends a unicast read request to read the data from the SRAM 1.

Going back to FIG. 10, the GDMA 1011 works with the external storage controller 1001 and is used for controlling memory accesses from the SRAM 1008 to the DRAM 904 in the clusters 1005 or reading the data from the DRAM 904 to the SRAM 1008 in the clusters 1005. It may be known from the above that communication between the DRAM 904 and the NRAM 1131 or the WRAM 1132 may be implemented through two channels. A first channel is to directly contact the DRAM 904 with the NRAM 1131 or the WRAM 1132 through an IODAM 1133. A second channel is to transfer the data between the DRAM 904 and the SRAM 1008 through the GDMA 1011 first, and then to transfer the data between the SRAM 1008 and the NRAM 1131 or the WRAM 1132 through the MVDMA 1134. Although it seems that the second channel requires more components and has long data flows, in fact, in some embodiments, the bandwidth of the second channel is much greater than that of the first channel. Therefore, the communication between the DRAM 904 and the NRAM 1131 or the WRAM 1132 may be more efficient through the second channel. The embodiment of the present disclosure may select a data transfer channel according to hardware conditions.

In other embodiments, a function of the GDMA 1011 and a function of the IODMA 1133 may be integrated in the same component. For the sake of description, the GDMA 1011 and the IODMA 1133 are viewed as different components in the present disclosure. For those skilled in the art, as long as functions and technical effects realized by components are similar to the present disclosure, the components shall fall within the scope of protection of the present disclosure. Further, the function of GDMA 1011, the function of IODMA 1133, a function of CDMA 1010, and a function of MVDMA 1134 may also be implemented by the same component. Similarly, as long as functions and technical effects realized by a component are similar to those of the present disclosure, the component shall fall within the scope of protection of the present disclosure.

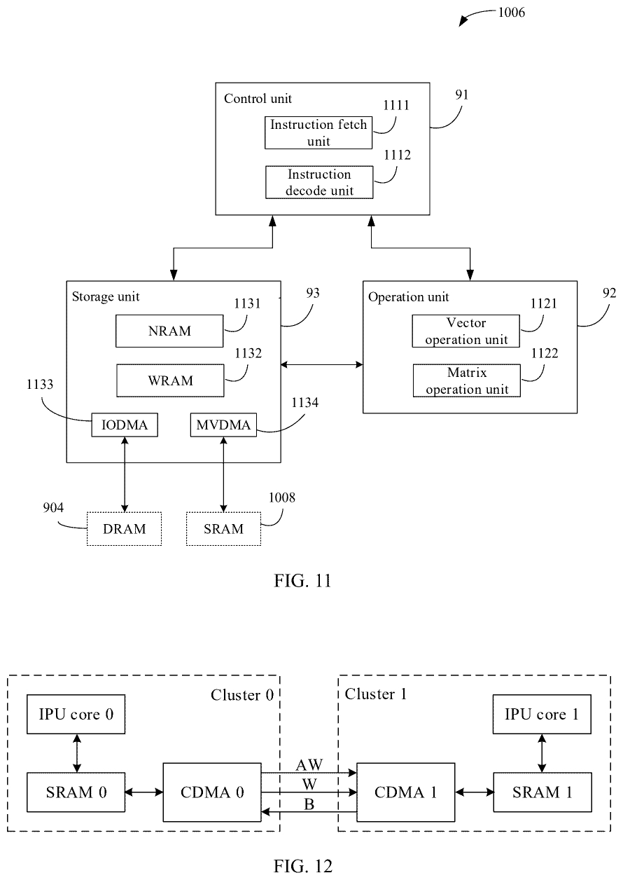

The software and hardware architecture and its internal structure are described in detail above in combination with FIG. 7 to FIG. 12. It may be understood that the description here is only exemplary but not restrictive. According to different application scenarios and hardware specifications, those skilled in the art may also make changes to the disclosed board card (or called an AI device) and its internal structure, and these changes still fall within the scope of protection of the present disclosure.

On the basis of the above description, those skilled in the art may understand that the present disclosure also discloses a device, including a processor and a memory. Specifically, the memory may store program instructions for task scheduling. When the program instructions are executed by the processor, steps of the disclosed scheduling operation described in combination with FIG. 1 to FIG. 6 are realized. In addition, since the scheme of the present disclosure may be realized by computing program instructions, the present disclosure also discloses a computer-readable storage medium or computer program product, on which computer programs/instructions for task scheduling are stored, thereby realizing steps of the disclosed scheduling operation described in combination with FIG. 1 to FIG. 6.

The above scheme is described in detail in combination with the attached drawings. According to different application scenarios, a device or apparatus of the present disclosure may include a server, a cloud server, a server cluster, a data processing apparatus, a robot, a computer, a printer, a scanner, a tablet, a smart terminal, a PC device, an Internet of Things terminal, a mobile terminal, a mobile phone, a traffic recorder, a navigator, a sensor, a webcam, a camera, a video camera, a projector, a watch, a headphone, a mobile storage, a wearable device, a visual terminal, an autonomous driving terminal, a vehicle, a household appliance, and/or a medical device. The vehicle includes an airplane, a ship, and/or a car; the household appliance includes a television, an air conditioner, a microwave oven, a refrigerator, an electric rice cooker, a humidifier, a washing machine, an electric lamp, a gas cooker, and a range hood; and the medical device includes a nuclear magnetic resonance spectrometer, a B-ultrasonic scanner, and/or an electrocardiograma device or apparatus of the present disclosure may be further applied to Internet, Internet of Things, data center, energy, transportation, public management, manufacturing, education, power grid, telecommunications, finance, retail, construction sites, medical, and other fields.

Further, the device or apparatus of the present disclosure may be further used in application scenarios including cloud, edge, and terminal related to artificial intelligence, big data, and/or cloud computing. In one or a plurality of embodiments, according to the disclosed scheme, a device or apparatus with high power consumption may be applied to a cloud device (such as the cloud server), while an electronic device or apparatus with low power consumption may be applied to a terminal device and/or an edge device (such as a smart phone or the webcam). In one or more embodiments, hardware information of the cloud device is compatible with that of the terminal device and/or the edge device. As such, according to the hardware information of the terminal device and/or the edge device, appropriate hardware resources may be matched from hardware resources of the cloud device to simulate hardware resources of the terminal device and/or the edge device to complete unified management, scheduling, and collaborative work of terminal-cloud integration or cloud-edge-terminal integration.

It is required to be explained that, for the sake of brevity, the present disclosure describes some method embodiments as a series of actions and combinations thereof, but those skilled in the art may understand that the solution of the present disclosure is not limited by an order of actions described. Therefore, according to the present disclosure or under the teaching of the present disclosure, those skilled in the art may understand that some steps of the method embodiments may be performed in a different order or simultaneously. Further, those skilled in the art may understand that the embodiments described in the present disclosure may be regarded as optional embodiments; in other words, actions and units involved thereof are not necessarily required for the implementation of a certain solution or some solutions of the present disclosure. Additionally, according to different solutions, descriptions of some embodiments of the present disclosure have their own emphases. In view of this, those skilled in the art may understand that, for a part that is not described in detail in a certain embodiment of the present disclosure, reference may be made to related descriptions in other embodiments.

In terms of specific implementations, according to the present disclosure and under the teaching of the present disclosure, those skilled in the art may understand that several embodiments disclosed in the present disclosure may be implemented in other ways that are not disclosed in the present disclosure. For example, for units in the electronic device or apparatus embodiment, the present disclosure splits the units on the basis of considering logical functions, but there may be other division methods during actual implementations. For another example, a plurality of units or components may be combined or integrated into another system, or some features or functions in the units or components may be selectively disabled. With respect to a connection between different units or components, the connection discussed above in combination with drawings may be direct or indirect coupling between the units or components. In some scenarios, the direct or indirect coupling involves a communication connection using an interface. The communication interface may support electrical, optical, acoustic, magnetic, or other forms of signal transmission.

In the present disclosure, units described as separate components may be or may not be physically separated. Components shown as units may be or may not be physical units. The components or units may be located in a same position or distributed to a plurality of network units. Additionally, according to actual requirements, some or all of the units may be selected for achieving the purpose of the solution described in the embodiments of the present disclosure. Additionally, in some scenarios, the plurality of units in the embodiments of the present disclosure may be integrated into one unit, or each of the units may be physically separated.

In some implementation scenarios, the above integrated unit may be implemented in the form of a software program unit. If the integrated unit is implemented in the form of the software program unit and sold or used as an independent product, the integrated unit may be stored in a computer-readable memory. Based on this, when the disclosed scheme is embodied in the form of a software product (such as a computer-readable storage medium), the software product may be stored in a memory. The software product may include several instructions used to enable a computer device (which may be a personal computer, a server, or a network device, and the like) to perform part or all of steps of the method of the embodiments of the present disclosure. The memory includes but is not limited to an USB, a flash disk, a read only memory (ROM), a random access memory (RAM), a mobile hard disk, a magnetic disk, or an optical disc, and other media that may store a program code.

In some other implementation scenarios, the integrated unit may be implemented in the form of hardware. The hardware may be a specific hardware circuit, which may include a digital circuit and/or an analog circuit, and the like. A physical implementation of a hardware structure of the circuit includes but is not limited to a physical component. The physical component includes but is not limited to a transistor, or a memristor, and the like. In view of this, various apparatuses (such as the computing apparatus or other processing apparatus) described in the present disclosure may be implemented by an appropriate hardware processor, such as a central processing unit (CPU), a graphics processing unit (GPU), a field-programmable gate array (FPGA), a digital signal processor (DSP), and an application-specific integrated circuit (ASIC), and the like. Further, the storage unit or the storage apparatus may be any appropriate storage medium (including a magnetic storage medium or a magneto-optical storage medium), such as a resistive random access memory (RRAM), a dynamic random access memory (DRAM), a static random access memory (SRAM), an enhanced dynamic random access memory (EDRAM), a high bandwidth memory (HBM), a hybrid memory cube (HMC), a read only memory (ROM), and a random access memory (RAM), and the like.

The foregoing may be better understood according to following articles.

Article A1. A task scheduler arranged in an artificial intelligence processor, where the artificial intelligence processor further includes an executing circuit configured to execute a task, and the task scheduler includes:
a first sending circuit configured to send a prefetch task of a next task to the executing circuit during an execution of a real task of a current task by the executing circuit, where a task in the task scheduler is split into a prefetch task and a real task that are interrelated; and
a second sending circuit configured to send a real task of the next task to the executing circuit after the executing circuit has completed an execution of the prefetch task of the next task, so that the executing circuit executes the real task of the next task after the executing circuit has completed the execution of the real task of the current task.

Article A2. The task scheduler of article A1, further including:
a first receiving circuit configured to receive the task that is split by a program instruction into a prefetch task and a real task that are interrelated; or
a splitting circuit configured to split the received task into a prefetch task and a real task that are interrelated.

Article A3. The task scheduler of article A1, where in sending the prefetch task of the next task to the executing circuit during the execution of the real task of the current task by the executing circuit, the second sending circuit is further configured to:
send the prefetch task of the next task to the executing circuit at a predetermined time before the execution of the real task of the current task is completed, so that the executing circuit executes the prefetch task of the next task during the execution of the real task of the current task by the executing circuit.

Article A4. The task scheduler of article A1, further including:
a second receiving circuit configured to receive a pre-finish indication of the real task of the current task from the executing circuit, where
the first sending circuit is configured to send the prefetch task of the next task to the executing circuit in response to receiving the pre-finish indication, so that the executing circuit releases hardware resources to execute the prefetch task of the next task.

Article A5. The task scheduler of any one of articles A1-A4, further including:
a third receiving circuit configured to receive a finish indication of the prefetch task of the next task from the executing circuit; and
a timer configured to time the execution of the real task of the current task by the executing circuit in response to receiving the finish indication of the prefetch task of the next task from the executing circuit.

Article A6. The task scheduler of article A5, further including:
a fourth receiving circuit configured to receive an unfinished indication used to indicate that the execution of the real task has not been completed from the executing circuit, where the first sending circuit is configured to send the prefetch task of the next task to the executing circuit or to another executing circuit in response to receiving the unfinished indication.

Article A7. The task scheduler of article A5, where the first sending circuit is further configured to send the prefetch task of the next task to the executing circuit or another executing circuit in response to a case where the timing of the timer exceeds a preset threshold and no indication is received from the executing circuit.

Article A8. The task scheduler of article A6 or A7, where in sending the prefetch task of the next task to the executing circuit or another executing circuit, the first sending circuit is further configured to:
place the prefetch task of the next task into a priority sending queue, so that the prefetch task of the next task is re-sent to the executing circuit or another executing circuit with the highest sending permission.

Article A9. The task scheduler of article A1, further including:
a recording circuit configured to record an error that occurs during the execution of the prefetch task.

Article A10. The task scheduler of article A9, further including:
an error reporting circuit configured to report the error when a real task that is interrelated with the prefetch task is executed.

Article A11. The task scheduler of article A1, where the executing circuit includes a plurality of intelligent processing unit (IPU) cores for executing tasks in parallel, where the task is split into a plurality of sub-tasks and each sub-task is executed by a corresponding IPU core, and the task scheduler is further configured to:
interact with the plurality of IPU cores, so that the plurality of IPU cores execute prefetch sub-tasks and real sub-tasks of corresponding sub-tasks in parallel.

Article A12. The task scheduler of article A11, where in interacting with the plurality of IPU cores to execute tasks, the first sending circuit is further configured to:
send a corresponding prefetch sub-task of a next task to each of the plurality of IPU cores in response to receiving a pre-finish indication of a prefetch sub-task of a current task from all the plurality of IPU cores, where
the second sending circuit is further configured to send a corresponding real sub-task of the next task to each of the plurality of IPU cores for execution in parallel by the plurality of IPU cores in response to receiving both a finish indication of a real sub-task of the current task and a pre-finish indication of the prefetch sub-task of the next task from all the plurality of IPU cores.

Article A13. The task scheduler of any one of articles A1-A12, where the prefetch task includes at least one of fetching an instruction, querying a translation lookaside buffer and/or translating a virtual address to a physical address.

Article A14. The task scheduler of article A13, where translating the virtual address to the physical address is implemented by a page table query, and the predetermined time is determined based on the number of levels of the page table in the page table query and the delay of the page table at each level.

Article A15. The task scheduler of article A13, where the real task includes executing the instruction.

Article A16. An artificial intelligence processor, including:
an executing circuit configured to execute a plurality of tasks; and
the task scheduler of any one of articles A1-A15, which is configured to interact with the executing circuit, so that the scheduled plurality of tasks are executed by the executing circuit.

Article A17. A board card, including the artificial intelligence processor of article A16.

Article A18. A method for executing task scheduling, including:

sending a prefetch task of a next task to an executing circuit during an execution of a real
task of a current task by the executing circuit, where the task is split into a prefetch task and a real task that are interrelated; and sending a real task of the next task to the executing circuit after the executing circuit has completed an execution of the prefetch task of the next task, so that the executing circuit executes the real task of the next task after the executing circuit has completed the execution of the real task of the current task.

Article A19. The method of article A18, further including:
receiving the task that is split by a program instruction into a prefetch task and a real task that are interrelated; or
splitting the received task into a prefetch task and a real task that are interrelated.

Article A20. The method of article A18, where in sending the prefetch task of the next task to the executing circuit during the execution of the real task of the current task by the executing circuit, the method further includes:
sending the prefetch task of the next task to the executing circuit at a predetermined time before the execution of the real task of the current task is completed, so that the executing circuit executes the prefetch task of the next task during the execution of the real task of the current task by the executing circuit.

Article A21. The method of article A18, further including:
receiving a pre-finish indication of the real task of the current task from the executing circuit; and
releasing hardware resources of the executing circuit to execute the prefetch task of the next task in response to receiving the pre-finish indication.

Article A22. The method of any one of articles A18-A21, further including:
timing the execution of the real task of the current task by the executing circuit in response to receiving a finish indication of the prefetch task of the next task from the executing circuit.

Article A23. The method of article A22, further including:
receiving an unfinished indication used to indicate that the execution of the real task has not been completed from the executing circuit in response to a case where the timing exceeds a preset threshold; and
sending the prefetch task of the next task to the executing circuit or to another executing circuit in response to receiving the unfinished indication.

Article A24. The method of article A22, further including:
sending the prefetch task of the next task to the executing circuit or another executing circuit in response to a case where the timing exceeds a preset threshold and no indication is received from the executing circuit.

Article A25. The method of article A23 or A24, where in sending the prefetch task of the next task to the executing circuit or another executing circuit, the method further includes:
placing the prefetch task of the next task into a priority sending queue, so that the prefetch task of the next task is re-sent to the executing circuit or another executing circuit with the highest sending permission.

Article A26. The method of article A18, further including:
recording an error that occurs during the execution of the prefetch task.

Article A27. The method of article A26, further including:
reporting the error when a real task that is interrelated with the prefetch task is executed.

Article A28. The method of article A18, where the executing circuit includes a plurality of IPU cores for executing tasks in parallel, where the task is split into a plurality of sub-tasks and each sub-task is executed by a corresponding IPU core, and the method further includes:
interacting with the plurality of IPU cores, so that the plurality of IPU cores execute prefetch sub-tasks and real sub-tasks of corresponding sub-tasks in parallel.

Article A29. The method of article A28, where in interacting with the plurality of IPU cores to execute tasks, the method further includes:
sending a corresponding prefetch sub-task of a next task to each of the plurality of IPU cores in response to receiving a pre-finish indication of a prefetch sub-task of a current task from all the plurality of IPU cores; and sending a corresponding real sub-task of the next task to each of the plurality of IPU cores for execution in parallel by the plurality of IPU cores in response to receiving both a finish indication of a real sub-task of the current task and a pre-finish indication of the prefetch sub-task of the next task from all the plurality of IPU cores.

Article A30. The method of any one of articles A18-A29, where the prefetch task includes at least one of fetching an instruction, querying a translation lookaside buffer and/or translating a virtual address to a physical address.

Article A31. The method of article A30, where translating the virtual address to the physical address is implemented by a page table query, and the predetermined time is determined based on the number of levels of the page table of the page table query and the delay of the page table at each level.

Article A32. The method of article A30, where the real task includes executing the instruction.

Article A33. A device configured to schedule and execute a task, including:
a processor; and a memory on which program instructions for task scheduling are stored, where when the program instructions are executed by the processor, the method described in any of articles A18-A32 is implemented.

Article A34. A computer-readable storage medium, on which program instructions for task scheduling are stored, where when the program instructions are executed by a processor, the method of any one of articles A18-A32 is implemented.

Although the embodiments of the present disclosure are as above, the contents are only embodiments used to facilitate the understanding of the present disclosure, and are not intended to limit the scope and application scenarios of the present disclosure. Any skilled personnel in the technical field of the present disclosure may make any modification and change in the form and details of the embodiments without deviating from the spirit and scope disclosed by the present disclosure, but the scope of patent protection of the present disclosure shall still be defined in the scope of the attached claims.

1. A task scheduler arranged in an artificial intelligence processor, wherein the artificial intelligence processor further comprises an executing circuit configured to execute a task, and the task scheduler comprises:
a first sending circuit configured to send a prefetch task of a next task to the executing circuit during an execution of a real task of a current task by the executing circuit, wherein a task in the task scheduler is split into a prefetch task and a real task that are interrelated; and
a second sending circuit configured to send a real task of the next task to the executing circuit after the executing circuit has completed an execution of the prefetch task of the next task, so that the executing circuit executes the real task of the next task after the executing circuit has completed the execution of the real task of the current task.

2. The task scheduler of claim 1, further comprising:
a first receiving circuit configured to receive the task that is split by a program instruction into a prefetch task and a real task that are interrelated; or
a splitting circuit configured to split the received task into a prefetch task and a real task that are interrelated.

3. The task scheduler of claim 1, wherein in sending the prefetch task of the next task to the executing circuit during the execution of the real task of the current task by the executing circuit, the second sending circuit is further configured to:
send the prefetch task of the next task to the executing circuit at a predetermined time before the execution of the real task of the current task is completed, so that the executing circuit executes the prefetch task of the next task during the execution of the real task of the current task by the executing circuit.

4. The task scheduler of claim 1, further comprising:
a second receiving circuit configured to receive a pre-finish indication of the real task of the current task from the executing circuit, wherein
the first sending circuit is configured to send the prefetch task of the next task to the executing circuit in response to receiving the pre-finish indication, so that the executing circuit releases hardware resources to execute the prefetch task of the next task.

5. The task scheduler of claim 1, further comprising:
a third receiving circuit configured to receive a finish indication of the prefetch task of the next task from the executing circuit; and
a timer configured to time the execution of the real task of the current task by the executing circuit in response to receiving the finish indication of the prefetch task of the next task from the executing circuit.

6. The task scheduler of claim 5, further comprising:
a fourth receiving circuit configured to receive an unfinished indication used to indicate that the execution of the real task has not been completed from the executing circuit, wherein
the first sending circuit is configured to send the prefetch task of the next task to the executing circuit or to another executing circuit in response to receiving the unfinished indication.

7. The task scheduler of claim 5, wherein the first sending circuit is further configured to send the prefetch task of the next task to the executing circuit or another executing circuit in response to a case where the timing of the timer exceeds a preset threshold and no indication is received from the executing circuit.

8. The task scheduler of claim 6, wherein in sending the prefetch task of the next task to the executing circuit or another executing circuit, the first sending circuit is further configured to:
place the prefetch task of the next task into a priority sending queue, so that the prefetch task of the next task is re-sent to the executing circuit or another executing circuit with the highest sending permission.

9. The task scheduler of claim 1, further comprising:
a recording circuit configured to record an error that occurs during the execution of the prefetch task-; and
an error reporting circuit configured to report the error when a real task that is interrelated with the prefetch task is executed.

10. (canceled)

11. The task scheduler of claim 1, wherein the executing circuit comprises a plurality of intelligent processing unit (IPU) cores for executing tasks in parallel, wherein the task is split into a plurality of sub-tasks and each sub-task is executed by a corresponding IPU core, and the task scheduler is further configured to:
interact with the plurality of IPU cores, so that the plurality of IPU cores execute prefetch sub-tasks and real sub-tasks of corresponding sub-tasks in parallel.

12-17. (canceled)

18. A method for executing task scheduling, comprising:
sending a prefetch task of a next task to an executing circuit during an execution of a real task of a current task by the executing circuit, wherein the task is split into a prefetch task and a real task that are interrelated; and
sending a real task of the next task to the executing circuit after the executing circuit has completed an execution of the prefetch task of the next task, so that the executing circuit executes the real task of the next task after the executing circuit has completed the execution of the real task of the current task.

19. The method of claim 18, further comprising:
receiving the task that is split by a program instruction into a prefetch task and a real task that are interrelated; or
splitting the received task into a prefetch task and a real task that are interrelated.

20. The method of claim 18, wherein in sending the prefetch task of the next task to the executing circuit during the execution of the real task of the current task by the executing circuit, the method further comprises:
sending the prefetch task of the next task to the executing circuit at a predetermined time before the execution of the real task of the current task is completed, so that the executing circuit executes the prefetch task of the next task during the execution of the real task of the current task by the executing circuit.

21. The method of claim 18, further comprising:
receiving a pre-finish indication of the real task of the current task from the executing circuit; and
releasing hardware resources of the executing circuit to execute the prefetch task of the next task in response to receiving the pre-finish indication.

22. The method of claim 18, further comprising:
timing the execution of the real task of the current task by the executing circuit in response to receiving a finish indication of the prefetch task of the next task from the executing circuit.

23. The method of claim 22, further comprising:
receiving an unfinished indication used to indicate that the execution of the real task has not been completed from the executing circuit in response to a case where the timing exceeds a preset threshold; and
sending the prefetch task of the next task to the executing circuit or to another executing circuit in response to receiving the unfinished indication.

24. The method of claim 22, further comprising:
sending the prefetch task of the next task to the executing circuit or another executing circuit in response to a case where the timing exceeds a preset threshold and no indication is received from the executing circuit.

25. The method of claim 23, wherein in sending the prefetch task of the next task to the executing circuit or another executing circuit, the method further comprises:
placing the prefetch task of the next task into a priority sending queue, so that the prefetch task of the next task is re-sent to the executing circuit or another executing circuit with the highest sending permission.

26. The method of claim 18, further comprising:
recording an error that occurs during the execution of the prefetch task-; and
reporting the error when a real task that is interrelated with the prefetch task is executed.

27. (canceled)

28. The method of claim 18, wherein the executing circuit comprises a plurality of IPU cores for executing tasks in parallel, wherein the task is split into a plurality of sub-tasks and each sub-task is executed by a corresponding IPU core, and the method further comprises:
interacting with the plurality of IPU cores, so that the plurality of IPU cores execute prefetch sub-tasks and real sub-tasks of corresponding sub-tasks in parallel.

29-34. (canceled)
